(19) United States
(12) Patent Application Publication
(10) Pub. No.: US 2022/0368394 A1
(43) Pub. Date: Nov. 17, 2022

(54) BEAM-STEERING ANTENNA ARRAY AUDIO ACCESSORY DEVICE

(71) Applicant: Starkey Laboratories, Inc., Eden Prairie, MN (US)

(72) Inventors: Paul Anders Shriner, Hopkins, MN (US); Gregory John Haubrich, Champlin, MN (US)

(21) Appl. No.: 17/755,243

(22) PCT Filed: Oct. 30, 2020
(86) PCT No.: PCT/US2020/070727

§ 371 Date: Apr. 25, 2022

Related U.S. Application Data
(60) Provisional application No. 62/927,947, filed on Oct. 30, 2019.

(51) Int. Cl. H04B 7/06; H04R 25/00; H01Q 3/26

(52) U.S. Cl. CPC H04B 7/0617; H04R 25/554; H01Q 3/2611; H04B 7/0626; H04R 2225/51; H04R 2499/15

(57) ABSTRACT

An audio transmission antenna array may be used to create multiple wireless audio beams, such as using beamforming and beam-steering. For example, individual control of the amplitude and phase of the radio frequency signals fed to each of the antenna elements within the array may be used to create a desired combined antenna pattern. This subject matter may be used for an audio streamer accessory, which may be used to stream audio wirelessly from a source directly to a hearing device, such as streaming audio from a TV to a viewer's audio streaming device. This may be used to provide improve audio performance in environments where multiple users stream audio from a single audio device, or where one or more users are moving around while using the streaming audio device. This may also be used to reduce or eliminate choppiness of audio that a digital audio source can produce.

### CROSS-REFERENCE TO RELATED APPLICATION

This application claims the benefit of U.S. Provisional Application No. 62/927,947, filed. Oct. 30, 2019, which is hereby incorporated by reference in its entirety.

### TECHNICAL FIELD

Embodiments described herein generally relate to wireless audio broadcast devices.

### BACKGROUND

Wireless audio broadcast systems may be used to broadcast audio to a nearby consumer of the audio. However, these wireless audio broadcast systems may have a limited broadcast range or provide intermittent audio. It is desirable to improve range and reliability of wireless audio transmission systems.

### BRIEF DESCRIPTION OF THE DRAWINGS

FIG. 1 is a beamforming audio streaming system, in accordance with at least one embodiment of the invention.

FIG. 2 is a beam-steering audio streaming system, in accordance with at least one embodiment of the invention.

FIG. 3 is an audio data transmission method for hearing assistance devices, in accordance with at least one embodiment of the invention.

FIG. 4 illustrates a block diagram of an example machine upon which any one or more of the techniques discussed herein may perform.

### DESCRIPTION OF EMBODIMENTS

The subject matter described herein includes using an audio streaming and control signal transmission antenna array to create multiple wireless radio frequency beams (e.g., shaped antenna gain patterns), such as using beamforming and beam-steering. For example, individual control of the amplitude and phase of the radio frequency signals fed to each of the antenna elements within the array may be used to create a desired combined antenna pattern. This subject matter may be used for an audio streamer accessory, which may be used to stream digitally encoded audio wirelessly from a source directly to a hearing device, such as streaming audio from a TV to a viewer's audio streaming device, such as headphones, hearing aids, hearing assistance device, ear-worn audio device, audio-enabled remote control, Remote Microphone+by Starkey Hearing Technologies, and other audio streaming devices. This may be used to provide improve wireless streaming performance in environments where multiple users (e.g., hearing device wearers) stream from a single device, or where one or more of the users are moving around while using the streaming device. This may also be used to reduce or eliminate choppiness of the received audio that a digital audio source can produce, or may be used when other people in the room may not have hearing loss and there is a difference in the necessary volume for the two groups.

This creation of multiple wireless audio beams provides technical solutions to address technical problems facing wireless audio transmission systems. These broadcast systems may broadcast from one or more transmission sources to one or more reception devices. For example, a 1-to-N system may broadcast from one transmission source to N reception devices. In another example, an M-to-N system may broadcast from M transmission sources to N reception devices, where N is greater than or equal to M. Transmission protocols are often duty-cycled to enable transmission from one or more transmission sources to one or more reception devices. In an example, a transmission protocol may include a 20% duty cycle, which may enable a single transmission source to provide a separate audio stream in up to five time slots to up to five distinct reception devices. This allows sequential transmissions with antenna pattern steering for each directional transmission. Additionally, when two hearing device wearers are listing to the same audio source, two time slots can be used to beam each in different directions.

These technical solutions may include modifying wireless transmission parameters for two or more antennas within a wireless transmission antenna array via beamforming and beam-steering to improve wireless audio transmission and reception for a user location. The modified wireless transmission parameters may include modified gain, modified phase, and other modified parameters. By modifying these wireless transmission parameters, the antenna gain pattern for two or more antennas may be modified to create constructive or destructive interference, which results in modifying the effective shape and direction of one or more wireless transmissions, such as to create a particular transmission beam to a user location. As used herein, beamforming refers to modifying antenna gain pattern shape and direction, and beam-steering refers to dynamically modifying the shape and direction. For example, beamforming may be used to increase streaming audio range to a particular user location, and beam-steering may adjust the direction of that streaming audio transmission dynamically to follow a moving user. These modified wireless transmissions may be used to extend the reception distance of the streamed audio to one or more users, and may be actively steered to follow one or more moving users. The wireless transmission antenna array may improve detection of the use of technical solutions described herein, such as if an audio streaming device included multiple antennas or phase shifters. While the subject matter is described herein using example embodiments that include a TV streaming device and hearing assistance devices (e.g., ear-worn hearing devices), other audio streaming transmission and reception devices may be used. For example, in place of or in addition to audio streaming, this subject matter may be used to transmit and receive data to convey status information, control information, or other data to support the transmission and reception devices.

This description of embodiments of the present subject matter refers to subject matter in the accompanying drawings, which show, by way of illustration, specific aspects and embodiments in which the present subject matter may be practiced. These embodiments are described in sufficient detail to enable those skilled in the art to practice the present subject matter. References to “an,” “one,” or “various” embodiments in this disclosure are not necessarily to the same embodiment, and such references contemplate more than one embodiment. The above detailed description is demonstrative and not to be taken in a limiting sense. The scope of the present subject matter is defined by the appended claims, along with the full scope of legal equivalents to which such claims are entitled.

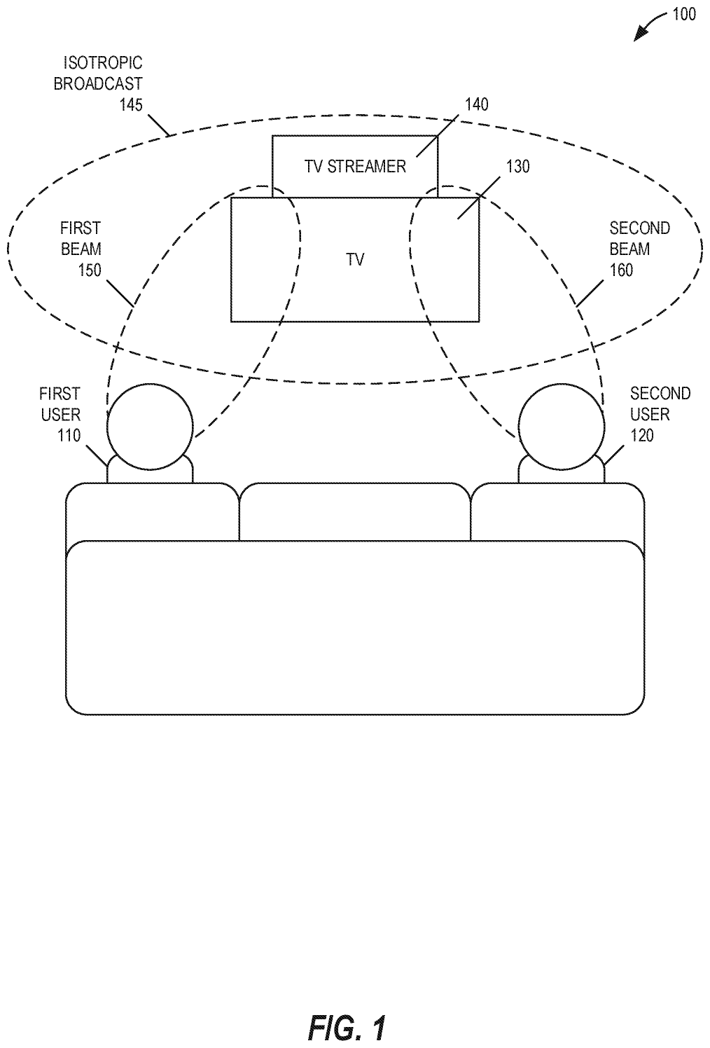

FIG. 1 is a beamforming audio streaming system 100, in accordance with at least one embodiment of the invention. System 100 may provide wireless audio to one or more users, such as first user 110 and second user 120. System 100 may include a TV 130 and a TV streamer 140, where TV streamer 140 receives an audio signal from the TV 130 and streams the audio wirelessly to first user 110 and second user 120. As can be seen in FIG. 1, a typical wireless transmission may include an isotropic (e.g., omnidirectional) broadcast 145, where the wireless radio frequency (RF) signal is broadcast in a substantially uniform (e.g., spherical) broadcast pattern. To improve broadcast range, the TV streamer 140 may use beamforming to generate a first beam 150 and second beam 160 directed toward first user 110 and second user 120, respectively. The first beam 150 and second beam 160 may be generated simultaneously or sequentially. For example, the first beam 150 may be generated in a first duty cycle time slot, and the second beam 160 may be generated in a second duty cycle time slot. Sequential beam generation may be used in duty-cycled protocols when streaming audio, such as in Bluetooth audio streaming.

The use of user-specific beams 150 and 160 provides various technical benefits. In addition to improving a communication range for reaching a particular user, these user-specific beams 150 and 160 may provide a more secure transmission link or increase efficiency. For example, in contrast with the isotropic broadcast 145, the user-specific beams 150 and 160 may reach the first user 110 and second user 120 using less overall effective radiated power and provide improved signal-to-noise ratio (SNR). In another example, if the first user 110 is determined to have a strong link with the TV streamer 140, a portion of the antenna transmission power budget (e.g., the antenna gain) may be reduced for the first user 110 and the remaining transmission power may be allocated toward second user 120 or other users with a more challenged wireless link. Similarly, a desired throughput or wireless link quality of signal may be modified by adjusting transmission power for the user-specific beams 150 and 160, by adjusting signal content redundancy, by adjusting signal content coding, by implementing error-correcting codes, or through other signal modifications.

In addition to focusing user-specific beams 150 and 160 toward users, the beams may be formed to reduce or minimize interference received from an interference source by placing the interference source in a null (es., local minimum) of the radiation pattern. The interference source may include an active interference source (e.g., wireless network operating at similar frequencies), or may include a passive interference source (e.g., multipath from metal surface). This directing of the null of the radiation pattern toward the interference source may improve the SNR by increasing the primary signal and reducing the noise. The beamforming, beam-steering, null-directing, and other solutions described herein also provides the ability to adapt to a static environment or a dynamically changing environment. For example, these solutions may provide the ability to direct user-specific beams toward moving users while directing nulls toward environment-specific multipath sources.

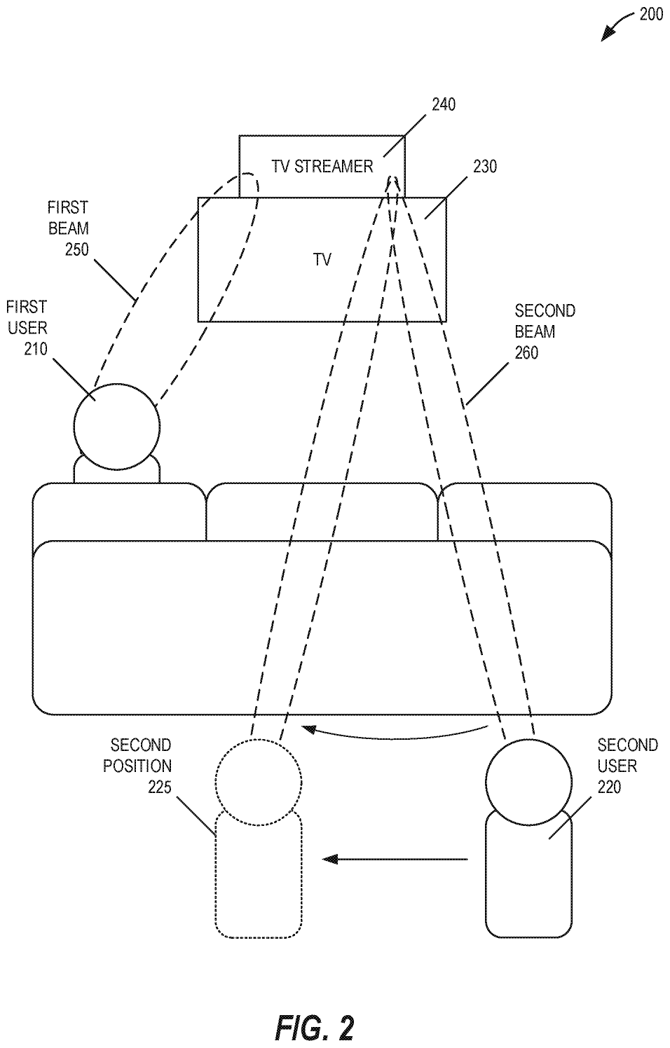

FIG. 2 is a beam-steering audio streaming system 200, in accordance with at least one embodiment of the invention. System 200 may provide wireless audio from TV streamer 240 to one or more users, such as first user 210 and second user 220. To improve broadcast range, the TV streamer 240 may use beamforming to generate a first beam 250 and second beam 260 directed toward first user 210 and second user 220, respectively. The second user 220 may shift to a second position 225, which may be outside of the primary lobe of the radiation pattern of the second beam 260. To maintain the connection between the second beam 260 and second user 220, beam-steering may be used to steer the second beam 260 in the direction of the second position 225.

The first beam 250 and second beam 260 may be formed and steered continually in the directions of the first user 210 and second user 220. Various methods may be used to form or steer each beam in the direction of the user. For beamforming and beam-steering, the phase and amplitude for two or more antennas may be modified to create constructive interference and destructive interference. In an example, the user device may provide a received signal strength indication (RSSI) or other signal information to the TV streamer 240, and the TV streamer 240 may use the signal information during beamforming or beam-steering. The TV streamer 240 may adjust signal phase and amplitude of signals transmitted from two or more two or more antennas while monitoring the user device signal information to improve or maximize the received signal strength at the user device. In an example, TV streamer 240 may use radio direction finding to approximate a user device direction. The TV streamer 240 may use a phased antenna array and signal information received from the user device to approximate the direction of the user device relative to the TV streamer 240. In an example, the user device may provide location or directional information directly to the TV streamer 240. The user device may provide a location or compass heading, and the TV streamer 240 may use knowledge of its own location or compass heading to determine a relative direction.

Directional information may be used to provide an improved connection with a hearing assistance device. For hearing assistance devices that include an independent receiving antenna in each of the right ear device and left ear device, directional information may be used in beamforming first beam 250 to direct the signal to be received equally by the left and right ear devices. This beamforming may assume that the user is looking primarily in the direction of the TV streamer 240. If signal information reported independently by the left and right ear devices is substantially different, then the TV streamer 240 may determine that a user is looking away from the TV streamer 240, and may further modify the first beam 250 to direct the signal to be received equally by the left and right ear devices. For hearing assistance devices that include one receiving antenna in a first ear device, where the first ear device transmits the other stereo channel to the second ear device, directional information may be used in beamforming first beam 250 to direct the signal to be received by the receiving antenna in the first ear device. Various combinations of these techniques may be used to form or steer each beam in the direction of the user.

These beamforming and beam-steering solutions may be used in combination with other static solutions to improve performance. For example, while these solutions enable a reduction in power by directing a beam toward a particular user, the range of these solutions may be further extended by increasing power, by implementing an improved matching RF network, or by designing a more efficient or directive antenna or antenna array.

The TV streamer 240 may operate in various frequencies and pairing modes. For example, TV streamer 240 may operate in the 900 MHz ISM band, the 2.4 GHz band, or other frequency bands. TV streamer 240 may operate using multiple frequencies simultaneously or sequentially (e.g., via frequency-hopping), such as by generating first beam 250 using a first frequency and generating second beam 260 using a second frequency. The hearing assistance devices may be paired with the TV streamer 240 and provide device-specific information back to the TV streamer 240, such as using a Bluetooth Low Energy (BLE) protocol. In various examples, BLE may be used to broadcast in an unpaired 1-to-N devices mode, in a paired 1-to-N devices mode, in an unpaired M-to-N devices mode, in a paired M-to-N devices mode, or in another BLE mode. The TV streamer 240 may be configured to provide multiple audio inputs and multiple channel BLE outputs, where the configuration of inputs and outputs may be based on which user devices are paired to the TV streamer 240.

A frequency-hopping mode may be selected to improve the performance of the TV streamer 240. In an example, adaptive frequency-hopping may be used, such as using Bluetooth adaptive frequency-hopping spread spectrum (AFH). Both the TV streamer 240 and the hearing assistance devices may use predetermined frequency hop channels, and may use Bluetooth or other scanning techniques to scan for and reduce interference caused by nearby interference sources. The frequency-hopping mode may be selected based on determination of signal time of flight (TOF) or angle of arrival (AOA), which may be used to spatially map hearing assistance devices to determine improved or optimized frequency-hopping configurations. A feedback loop may be used to integrate interference and skip interference channels. An advanced frequency-hopping could further improve frequency-hopping based on the TOF, AOA, and information about other potentially interfering wireless sources (e.g., cellphones, Wi-Fi devices).

The TV streamer 240 may use various techniques to increase the density of hearing assistance devices while reducing or minimizing interference sources. For example, TV streamer 240 may communicate with one or more Wi-Fi networks to reserve timeslots or frequency bands for time division multiplexing or frequency division multiplexing, respectively. For example, a Wi-Fi network may provide information to the TV streamer 240 about which timeslots or frequency bands to be used. Alternatively, the TV streamer 240 may provide information to the Wi-Fi network indicating the timeslots or frequency bands currently being used for audio streaming, and the Wi-Fi network may use alternative timeslots or frequency bands for its Wi-Fi transmissions. This use of a time scheduler or frequency scheduler may allow simultaneous usage of the Wi-Fi network and audio streaming from the TV streamer 240 while reducing or minimizing interference that might otherwise be caused by signals broadest in similar frequency ranges or timeslots.

A number of hearing assistance devices that may be connected to the TV streamer 240 may be based on a bandwidth of an audio channel. For example, a Bluetooth transmission may be tune-multiplexed to provide a full 64 kbps audio streaming signal using less than one-sixth of the full periodic time interval using in Bluetooth streaming, which may allow streaming to at least six different hearing assistance devices. For example, a Bluetooth transmission may use beamforming to generate six different beams in each of six time slots to stream to each of six nearby hearing assistance devices. The number of streaming hearing assistance devices may be increased further by using additional time division multiplexing, using frequency division multiplexing, using modified antenna patterns, using modified signal gain and phase, and using other signal parameters. In an example, the modification of these signal parameters may be implemented in within the physical layer (e.g., PHY layer) of the TV streamer 240.

The TV streamer 240 may be used to provide functionality beyond audio streaming. For example, the TV streamer 240 may be used to monitor the presence or location of multiple hearing assistance devices within range of the TV streamer 240. The monitoring features may be used to determine patterns in presence of hearing assistance device users, such as nearby areas of interest. The TV streamer 240 may be used to provide other wireless features, such as wireless charging of a hearing assistance device. For example, the TV streamer 240 may determine a location of a hearing assistance device that has been placed on a table or other nearby surface, and may use beamforming or beam-steering to direct a wireless charging transmission to wirelessly recharge the hearing assistance device.

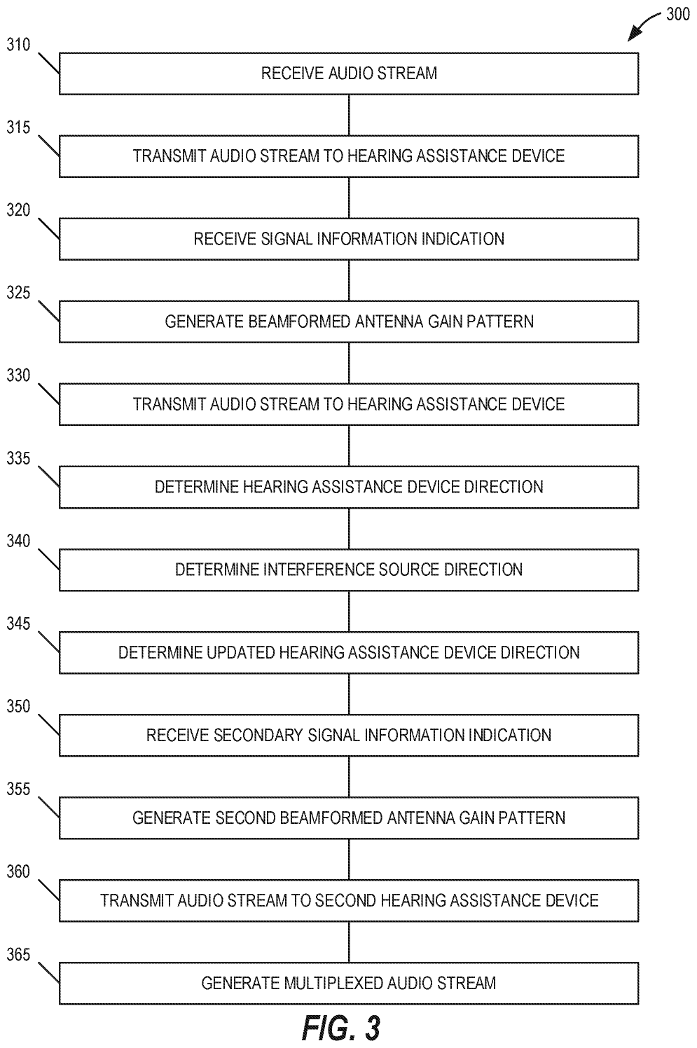

FIG. 3 is an audio data transmission method 300 for hearing assistance devices, in accordance with at least one embodiment of the invention. Method 300 may include receiving 310 an audio stream and transmitting 315 the audio stream to a hearing assistance device using an initial antenna gain pattern. Method 300 may include receiving 320 a signal information indication from the hearing assistance device, generating 325 a beamformed antenna gain pattern based on an improvement to the signal information indication, and transmitting 330 the audio stream to the hearing assistance device based on the beamformed antenna gain pattern. The signal information may include at least one of a received signal strength indication and a signal to noise ratio. The hearing assistance device may include a first ear device and a second ear device. The signal information indication may include a first ear signal indication associated with the first ear device and a second ear signal indication associated with the second ear device. The beamformed antenna gain pattern may be generated further based on the first ear signal indication and the second ear signal indication.

Method 300 may include determining 335 a hearing assistance device direction based on the signal information indication. The beamformed antenna gain pattern may be generated to direct the audio stream in the determined hearing assistance device direction. Method 300 may include determining 340 an interference source direction based on the signal information indication. The beamformed antenna gain pattern may be generated to direct a null of the beamformed antenna gain pattern in the interference source direction.

Method 300 may include determining 345 an updated hearing assistance device direction based on the signal information indication, where the updated hearing assistance device direction indicates a movement of the hearing assistance device from a first location to a second location. The beamformed antenna gain pattern may be generated to steer the audio stream from the determined hearing assistance device direction to the determined updated hearing assistance device direction.

Method 300 may include receiving 350 a secondary signal information indication from a second hearing assistance device, generating 355 a second beamformed antenna gain pattern based on the received secondary signal information indication, and transmitting 360 the audio stream to the second hearing assistance device based on the beamformed antenna gain pattern.

Method 300 may include generating 365 a multiplexed audio stream to transmit the audio stream to the hearing assistance device and to the second hearing assistance device. The multiplexed audio stream may include time division multiplexing. For example, the audio stream may be transmitted to the hearing assistance device during a first time slot, and the audio stream may be transmitted to the second hearing assistance device during a second time slot. The multiplexed audio stream may include frequency division multiplexing. For example, the audio stream may be transmitted to the hearing assistance device within a first frequency band, and the audio stream may be transmitted to the second hearing assistance device within a second frequency band.

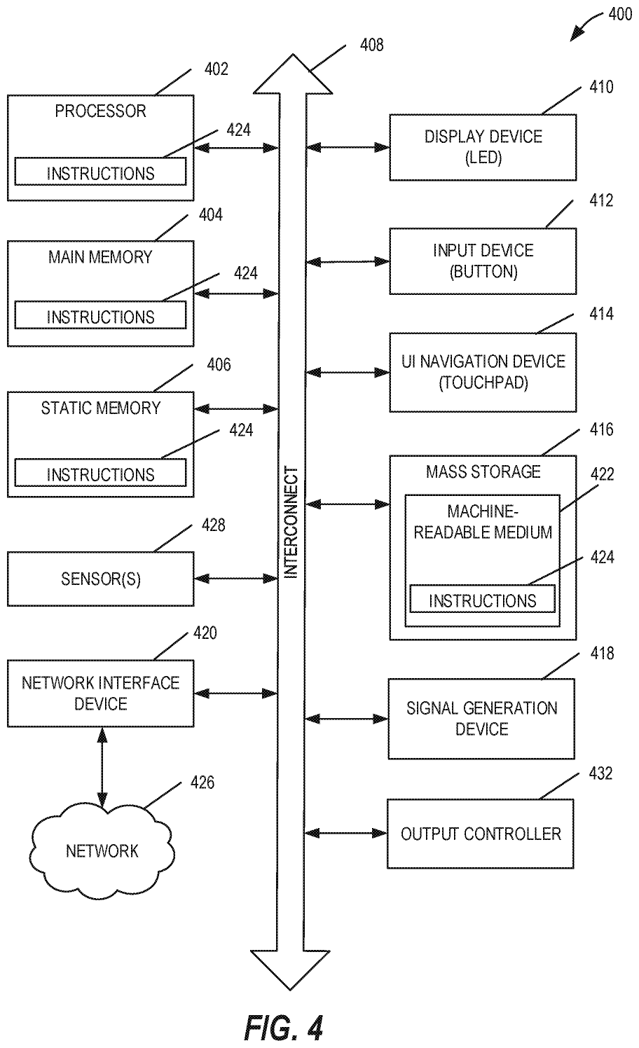

FIG. 4 illustrates a block diagram of an example machine 400 upon which any one or more of the techniques (e.g., methodologies) discussed herein may perform. In alternative embodiments, the machine 400 may operate as a standalone device or may he connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as location sensor (e.g., a global positioning system sensor), compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to communicate wirelessly using at least one of single-input multiple-output (SMO), multiple-input multiple-output (MIMO), or multiple-input single-output (MISO) techniques. The term “transmission medium” shall be taken to include any intangible medium that is capable of storing, encoding, or carrying instructions for execution by the machine 400, and includes digital or analog communications signals or other intangible medium to facilitate communication of such software.

Various embodiments of the present subject matter may include a hearing assistance device. Hearing assistance devices typically include at least one enclosure or housing, a microphone, hearing assistance device electronics including processing electronics, and a speaker or “receiver.” Hearing assistance devices may include a power source, such as a battery. In various embodiments, the battery may be rechargeable. In various embodiments multiple energy sources may be employed. It is understood that in various embodiments the microphone is optional. It is understood that in various embodiments the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples, drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

Various embodiments of the present subject matter support wireless communications with a hearing assistance device. In various embodiments, the wireless communications can include standard or nonstandard communications. Some examples of standard wireless communications include, but not limited to, Bluetooth™, low energy Bluetooth, IEEE 802.11 (wireless LANs), 802.15 (WPANs), and 802.16 (WiMAX). Cellular communications may include, but not limited to, CDMA, GSM, ZigBee, and ultra-wideband (UWB) technologies. in various embodiments, the communications are radio frequency communications. In various embodiments, the communications are optical communications, such as infrared communications. In various embodiments, the communications are inductive communications. In various embodiments, the communications are ultrasound communications. Although embodiments of the present system may be demonstrated as radio communication systems, it is possible that other forms of wireless communications can be used. It is understood that past and present standards can be used. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fiber-channel, Firewire or 1394, InfiniBand, or a native streaming interface. In various embodiments, such connections include all past and present link protocols. It is also contemplated that future versions of these protocols and new protocols may be employed without departing from the scope of the present subject matter.

In various embodiments, the present subject matter is used in hearing assistance devices that are configured to communicate with mobile phones. In such embodiments, the hearing assistance device may be operable to perform one or more of the following: answer incoming calls, hang up on calls, and/or provide two-way telephone communications. In various embodiments, the present subject matter is used in hearing assistance devices configured to communicate with packet-based devices. In various embodiments, the present subject matter includes hearing assistance devices configured to communicate with streaming audio devices. In various embodiments, the present subject matter includes hearing assistance devices configured to communicate with Wi-Fi devices. In various embodiments, the present subject matter includes hearing assistance devices capable of being controlled by remote control devices.

It is further understood that different hearing assistance devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer. The present subject matter may be employed in hearing assistance devices, such as headsets, hearing aids, headphones, and similar hearing devices. The present subject matter may be employed in hearing assistance devices having additional sensors. Such sensors include, but are not limited to, magnetic field sensors, telecoils, temperature sensors, accelerometers, and proximity sensors.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also he used in hearing assistance devices generally, such as cochlear implant type hearing devices and such as deep insertion devices having a transducer, such as a receiver or microphone, whether custom fitted, standard fitted, open fitted and/or occlusive fitted. It is understood that other hearing assistance devices not expressly stated herein may be used in conjunction with the present subject matter.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Example 1 is an audio and data transmission system for hearing assistance devices, the system comprising: a memory; and a processor configured to execute instructions to: receive an audio stream; wirelessly transmit the audio stream to a hearing assistance device based on an initial antenna gain pattern; determine a received signal information indication based on a communication with the hearing assistance device; generate a first beamformed antenna gain pattern based on an improvement to the received signal indication; and transmit the audio stream to the hearing assistance device using the first beamformed antenna gain pattern.

In Example 2, the subject matter of Example 1 optionally includes wherein: the hearing assistance device includes a first ear device and a second ear device; the received signal indication includes a first ear signal indication associated with the first ear device and a second ear signal indication associated with the second ear device; and the first beamformed antenna gain pattern is generated further based on the first ear signal indication and the second ear signal indication.

In Example 3, the subject matter of any one or more of Examples 1-2 optionally include the processor further configured to execute instructions to determine a beamforming direction based on the received signal indication; wherein the first beamformed antenna gain pattern is generated to direct a transmission of the audio stream in the determined beamforming direction.

In Example 4, the subject matter of Example 3 optionally includes the processor further configured to execute instructions to determine an interference beamforming direction based on the received signal indication; wherein the first beamformed antenna gain pattern is generated to direct a null of the first beamformed antenna gain pattern in the interference beamforming direction.

In Example 5, the subject matter of any one or more of Examples 3-4 optionally include the processor further configured to execute instructions to determine an updated beamforming direction based on the received signal indication, the updated beamforming direction indicating a movement of the hearing assistance device from a first location to a second location; wherein the first beamformed antenna gain pattern is generated to steer the audio stream from the determined beamforming direction to the determined updated beamforming direction.

In Example 6, the subject matter of any one or more of Examples 3-5 optionally include the processor further configured to execute instructions to determine a multipath beamforming direction based on the received signal indication, the multipath beamforming direction indicating a change in a multipath environment; wherein the first beamformed antenna gain pattern is generated to steer the audio stream from the determined beamforming direction to the determined multipath beamforming direction.

In Example 7, the subject matter of any one or more of Examples 1-6 optionally include the processor further configured to execute instructions to: receive a secondary received signal indication based on a second communication with a second hearing assistance device associated with a second user; generate a second beamformed antenna gain pattern based on the received secondary received signal indication, the second beamformed antenna gain pattern different from the first beamformed antenna gain pattern; and transmit the audio stream to the second hearing assistance device based on the second beamformed antenna gain pattern.

In Example 8, the subject matter of any one or more of Examples 1-7 optionally include the processor further configured to execute instructions to: transmit the audio stream to the hearing assistance device within a first time slot within a multiplexed audio stream; and transmit the audio stream to the second hearing assistance device within a second time slot within the multiplexed audio stream.

In Example 9, the subject matter of Example 8 optionally includes wherein: the multiplexed audio stream includes time division multiplexing; the audio stream is transmitted to the hearing assistance device during a first time slot; and the audio stream is transmitted to the second hearing assistance device during a second time slot.

In Example 10, the subject matter of any one or more of Examples 8-9 optionally include wherein: the multiplexed audio stream includes frequency division multiplexing; the audio stream is transmitted to the hearing assistance device within a first frequency channel; and the audio stream is transmitted to the second hearing assistance device within a second frequency channel.

In Example 11, the subject matter of any one or more of Examples 8-10 optionally include wherein the signal information includes at least one of a received signal strength indication provided by the hearing assistance device and a signal to noise ratio provided by the hearing assistance device.

Example 12 is an audio and data transmission method for hearing assistance devices, the method comprising: receiving an audio stream; wirelessly transmitting the audio stream to a hearing assistance device based on an initial antenna gain pattern; determining a received signal information indication based on a communication with the hearing assistance device; generating a first beamformed antenna gain pattern based on an improvement to the received signal indication; and transmitting the audio stream to the hearing assistance device using the first beamformed antenna gain pattern.

In Example 13, the subject matter of Example 12 optionally includes wherein: the hearing assistance device includes a first ear device and a second ear device; the received signal indication includes a first ear signal indication associated with the first ear device and a second ear signal indication associated with the second ear device; and the first beamformed antenna gain pattern is generated further based on the first ear signal indication and the second ear signal indication.

In Example 14, the subject matter of any one or more of Examples 12-13 optionally include determining a beamforming direction based on the received signal indication; wherein the first beamformed antenna gain pattern is generated to direct a transmission of the audio stream in the determined beamforming direction.

In Example 15, the subject matter of Example 14 optionally includes determining an interference beamforming direction based on the received signal indication; wherein the first beamformed antenna gain pattern is generated to direct a null of the first beamformed antenna gain pattern in the interference beamforming direction.

In Example 16, the subject matter of any one or more of Examples 14-15 optionally include determining an updated beamforming direction based on the received signal indication, the updated beamforming direction indicating a movement of the hearing assistance device from a first location to a second location; wherein the first beamformed antenna gain pattern is generated to steer the audio stream from the determined beamforming direction to the determined updated beamforming direction.

In Example 17, the subject matter of any one or more of Examples 14-16 optionally include determining a multipath beamforming direction based on the received signal indication, the multipath beamforming direction indicating a movement of the hearing assistance device from a first location to a second location; wherein the first beamformed antenna gain pattern is generated to steer the audio stream from the determined beamforming direction to the multipath beamforming direction.

In Example 18, the subject matter of any one or more of Examples 12-17 optionally include receiving a secondary received signal indication based on a second communication with a second hearing assistance device associated with a second user; generating a second beamformed antenna gain pattern based on the received secondary received signal indication, the second beamformed antenna gain pattern different from the first beamformed antenna gain pattern; and transmitting the audio stream to the second hearing assistance device based on the second beamformed antenna gain pattern.

In Example 19, the subject matter of any one or more of Examples 12-18 optionally include transmitting the audio stream to the hearing assistance device within a first time slot within a multiplexed audio stream; and transmitting the audio stream to the second hearing assistance device within a second time slot within the multiplexed audio stream.

In Example 20, the subject matter of Example 19 optionally includes wherein: the multiplexed audio stream includes time division multiplexing; the audio stream is transmitted to the hearing assistance device during a first time slot; and the audio stream is transmitted to the second hearing assistance device during a second time slot.

In Example 21, the subject matter of any one or more of Examples 19-20 optionally include wherein: the multiplexed audio stream includes frequency division multiplexing; the audio stream is transmitted to the hearing assistance device within a first frequency channel; and the audio stream is transmitted to the second hearing assistance device within a second frequency channel.

In Example 22, the subject matter of any one or more of Examples 19-21 optionally include wherein the signal information includes at least one of a received signal strength indication provided by the hearing assistance device and a signal to noise ratio provided by the hearing assistance device.

Example 23 is one or more machine-readable medium including instructions, which when executed by a computing system, cause the computing system to perform any of the methods of Examples 12-22.

Example 24 is an apparatus comprising means for performing any of the methods of Examples 12-22.

Example 25 is at least one non-transitory machine-readable storage medium, comprising a plurality of instructions that, responsive to being executed with processor circuitry of a computer-controlled device, cause the computer-controlled device to: receive an audio stream; wirelessly transmit the audio stream to a hearing assistance device based on an initial antenna gain pattern; determine a received signal information indication based on a communication with the hearing assistance device; generate a first beamformed antenna gain pattern based on an improvement to the received signal indication; and transmit the audio stream to the hearing assistance device using the first beamformed antenna gain pattern.

In Example 26, the subject matter of Example 25 optionally includes wherein: the hearing assistance device includes a first ear device and a second ear device; the received signal indication includes a first ear signal indication associated with the first ear device and a second ear signal indication associated with the second ear device; and the first beamformed antenna gain pattern is generated further based on the first ear signal indication and the second ear signal indication.

In Example 27, the subject matter of any one or more of Examples 25-26 optionally include the instructions further causing the computer-controlled device to determine a beamforming direction based on the received signal indication; wherein the first beamformed antenna gain pattern is generated to direct a transmission of the audio stream in the determined beamforming direction.

In Example 28, the subject matter of Example 27 optionally includes the instructions further causing the computer-controlled device to determine an interference beamforming direction based on the received signal indication; wherein the first beamformed antenna gain pattern is generated to direct a null of the first beamformed antenna gain pattern in the interference beamforming direction.

In Example 29, the subject matter of any one or more of Examples 27-28 optionally include the instructions further causing the computer-controlled device to determine an updated beamforming direction based on the received signal indication, the updated beamforming direction indicating a movement of the hearing assistance device from a first location to a second location; wherein the first beamformed antenna gain pattern is generated to steer the audio stream from the determined beamforming direction to the determined updated beamforming direction.

In Example 30, the subject matter of any one or more of Examples 27-29 optionally include the instructions further causing the computer-controlled device to determine a multipath beamforming direction based on the received signal indication, the multipath beamforming direction indicating a movement of the hearing assistance device from a first location to a second location; wherein the first beamformed antenna gain pattern is generated to steer the audio stream from the determined beamforming direction to the multipath beamforming direction.

In Example 31, the subject matter of any one or more of Examples 25-30 optionally include the instructions further causing the computer-controlled device to: receive a secondary received signal indication based on a second communication with a second hearing assistance device associated with a second user; generate a second beamformed antenna gain pattern based on the received secondary received signal indication, the second beamformed antenna gain pattern different from the first beamformed antenna gain pattern; and transmit the audio stream to the second hearing assistance device based on the second beamformed antenna gain pattern.

In Example 32, the subject matter of any one or more of Examples 25-31 optionally include the instructions further causing the computer-controlled device to: transmit the audio stream to the hearing assistance device within a first time slot within a multiplexed audio stream; and transmit the audio stream to the second hearing assistance device within a second time slot within the multiplexed audio stream.

In Example 33, the subject matter of Example 32 optionally includes wherein: the multiplexed audio stream includes time division multiplexing; the audio stream is transmitted to the hearing assistance device during a first time slot; and the audio stream is transmitted to the second hearing assistance device during a second time slot.

In Example 34, the subject matter of any one or more of Examples 32-33 optionally include wherein: the multiplexed audio stream includes frequency division multiplexing; the audio stream is transmitted to the hearing assistance device within a first frequency channel; and the audio stream is transmitted to the second hearing assistance device within a second frequency channel.

In Example 35, the subject matter of any one or more of Examples 32-34 optionally include wherein the signal information includes at least one of a received signal strength indication provided by the hearing assistance device and a signal to noise ratio provided by the hearing assistance device.

Example 36 is an audio and data transmission apparatus for hearing assistance devices, the apparatus comprising: means for receiving an audio stream; means for wirelessly transmitting the audio stream to a hearing assistance device based on an initial antenna gain pattern; means for determining a received signal information indication based on a communication with the hearing assistance device; means for generating a first beamformed antenna gain pattern based on an improvement to the received signal indication; and means for transmitting the audio stream to the hearing assistance device using the first beamformed antenna gain pattern.

In Example 37, the subject matter of Example 36 optionally includes wherein: the hearing assistance device includes a first ear device and a second ear device; the received signal indication includes a first ear signal indication associated with the first ear device and a second ear signal indication associated with the second ear device; and the first beamformed antenna gain pattern is generated further based on the first ear signal indication and the second ear signal indication.

In Example 38, the subject matter of any one or more of Examples 36-37 optionally include means for determining a beamforming direction based on the received signal indication; wherein the first beamformed antenna gain pattern is generated to direct a transmission of the audio stream in the determined beamforming direction.

In Example 39, the subject matter of Example 38 optionally includes means for determining an interference beamforming direction based on the received signal indication; wherein the first beamformed antenna gain pattern is generated to direct a null of the first beamformed antenna gain pattern in the interference beamforming direction.

In Example 40, the subject matter of any one or more of Examples 38-39 optionally include means for determining an updated beamforming direction based on the received signal indication, the updated beamforming direction indicating a movement of the hearing assistance device from a first location to a second location; wherein the first beamformed antenna gain pattern is generated to steer the audio stream from the determined beamforming direction to the determined updated beamforming direction.

In Example 41, the subject matter of any one or more of Examples 38-40 optionally include means for determining a multipath beamforming direction based on the received signal indication, the multipath beamforming direction indicating a movement of the hearing assistance device from a first location to a second location; wherein the first beamformed antenna gain pattern is generated to steer the audio stream from the determined beamforming direction to the multi path beamforming direction.

In Example 42, the subject matter of any one or more of Examples 36-41 optionally include means for receiving a secondary received signal indication based on a second communication with a second hearing assistance device associated with a second user; means for generating a second beamformed antenna gain pattern based on the received secondary received signal indication, the second beamformed antenna gain pattern different from the first beamformed antenna gain pattern; and means for transmitting the audio stream to the second hearing assistance device based on the second beamformed antenna gain pattern.

In Example 43, the subject matter of any one or more of Examples 36-42 optionally include means for transmitting the audio stream to the hearing assistance device within a first time slot within a multiplexed audio stream; and means for transmitting the audio stream to the second hearing assistance device within a second time slot within the multiplexed audio stream.

In Example 44, the subject matter of Example 43 optionally includes wherein: the multiplexed audio stream includes time division multiplexing; the audio stream is transmitted to the hearing assistance device during a first time slot; and the audio stream is transmitted to the second hearing assistance device during a second time slot.

In Example 45, the subject matter of any one or more of Examples 43-44 optionally include wherein: the multiplexed audio stream includes frequency division multiplexing; the audio stream is transmitted to the hearing assistance device within a first frequency channel; and the audio stream is transmitted to the second hearing assistance device within a second frequency channel.

In Example 46, the subject matter of any one or more of Examples 43-45 optionally include wherein the signal information includes at least one of a received signal strength indication provided by the hearing assistance device and a signal to noise ratio provided by the hearing assistance device.

Example 47 is one or more non-transitory machine-readable medium including instructions, which when executed by a machine, cause the machine to perform operations of any of the operations of Examples 1-46.

Example 48 is an apparatus comprising means for performing any of the operations of Examples 1-46.

Example 49 is a system to perform the operations of any of the Examples 1-46.

Example 50 is a method to perform the operations of any of the Examples 1-46.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance.

Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may he implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. An audio and data transmission system for hearing assistance devices, the system comprising:
a memory; and
a processor configured to execute instructions to:
receive an audio stream;
wirelessly transmit the audio stream to a hearing assistance device based on an initial antenna gain pattern;
determine a received signal information indication based on a communication with the hearing assistance device;
generate a first beamformed antenna gain pattern based on an improvement to the received signal indication; and
transmit the audio stream to the hearing assistance device using the first beamformed antenna gain pattern.

2. The audio and data transmission system of claim 1, wherein:
the hearing assistance device includes a first ear device and a second ear device;
the received signal indication includes a first ear signal indication associated with the first ear device and a second ear signal indication associated with the second ear device; and
the first beamformed antenna gain pattern is generated further based on the first ear signal indication and the second ear signal indication.

3. The audio and data transmission system of claim 1, the processor further configured to execute instructions to determine a beamforming direction based on the received signal indication;
wherein the first beamformed antenna gain pattern is generated to direct a transmission of the audio stream in the determined beamforming direction.

4. The audio and data transmission system of claim 1, the processor further configured to execute instructions to:
receive a secondary received signal indication based on a second communication with a second hearing assistance device associated with a second user;
generate a second beamformed antenna gain pattern based on the received secondary received signal indication, the second beamformed antenna gain pattern different from the first beamformed antenna gain pattern; and
transmit the audio stream to the second hearing assistance device based on the second beamformed antenna gain pattern.

5. The audio and data transmission system of claim 1, the processor further configured to execute instructions to:
transmit the audio stream to the hearing assistance device within a first time slot within a multiplexed audio stream; and
transmit the audio stream to the second hearing assistance device within a second time slot within the multiplexed audio stream.

6. The audio and data transmission system of claim 5, wherein the signal information includes at least one of a received signal strength indication provided by the hearing assistance device and a signal to noise ratio provided by the hearing assistance device.

7. An audio and data transmission method for hearing assistance devices, the method comprising:
receiving an audio stream;
wirelessly transmitting the audio stream to a hearing assistance device based on an initial antenna gain pattern;
determining a received signal information indication based on a communication with the hearing assistance device;
generating a first beamformed antenna gain pattern based on an improvement to the received signal indication; and
transmitting the audio stream to the hearing assistance device using the first beamformed antenna gain pattern.

8. The audio and data transmission method of claim 7, wherein:
the hearing assistance device includes a first ear device and a second ear device;
the received signal indication includes a first ear signal indication associated with the first ear device and a second ear signal indication associated with the second ear device; and.
the first beamformed antenna gain pattern is generated further based on the first ear signal indication and the second ear signal indication.

9. The audio and data transmission method of claim 7, further including determining a beamforming direction based on the received signal indication;
wherein the first beamformed antenna gain pattern is generated to direct a transmission of the audio stream in the determined beamforming direction.

10. The audio and data transmission method of claim 9, further including determining an interference beamforming direction based on the received signal indication;
wherein the first beamformed antenna gain pattern is generated to direct a null of the first beamformed antenna gain pattern in the interference beamforming direction.

11. The audio and data transmission method of claim 9, further including determining an updated beamforming direction based on the received signal indication, the updated beamforming direction indicating a movement of the hearing assistance device from a first location to a second location;
wherein the first beamformed antenna gain pattern is generated to steer the audio stream from the determined beamforming direction to the determined updated beamforming direction.

12. The audio and data transmission method of claim 9, further including determining a multi path beamforming direction based on the received signal indication, the multipath beamforming direction indicating a movement of the hearing assistance device from a first location to a second location;
wherein the first beamformed antenna gain pattern is generated to steer the audio stream from the determined beamforming direction to the multipath beamforming direction.

13. The audio and data transmission method of claim 7, further including:
receiving a secondary received signal indication based on a second communication with a second hearing assistance device associated with a second user;
generating a second beamformed antenna gain pattern based on the received secondary received signal indication, the second beamformed antenna gain pattern different from the first beamformed antenna gain pattern; and
transmitting the audio stream to the second hearing assistance device based on the second beamformed antenna gain pattern.

14. The audio and data transmission method of claim 7, further including:
transmitting the audio stream to the hearing assistance device within a first time slot within a multiplexed audio stream; and
transmitting the audio stream to the second hearing assistance device within a second time slot within the multiplexed audio stream.

15. The audio and data transmission method of claim 14, wherein:
the multiplexed audio stream includes time division multiplexing;
the audio stream is transmitted to the hearing assistance device during a first time slot; and
the audio stream is transmitted to the second hearing assistance device during a second time slot.

16. The audio and data transmission method of claim 14, wherein:
the multiplexed audio stream includes frequency division multiplexing;
the audio stream is transmitted to the hearing assistance device within a first frequency channel; and
the audio stream is transmitted to the second hearing assistance device within a second frequency channel.

17. The audio and data transmission method of claim 14, wherein the signal information includes at least one of a received signal strength indication provided by the hearing assistance device and a signal to noise ratio provided by the hearing assistance device.

18. At least one non-transitory machine-readable storage medium, comprising a plurality of instructions that, responsive to being executed with processor circuitry of a computer-controlled device, cause the computer-controlled device to:
receive an audio stream;
wirelessly transmit the audio stream to a hearing assistance device based on an initial antenna gain pattern;
determine a received signal information indication based on a communication with the hearing assistance device;
generate a first beamformed antenna gain pattern based on an improvement to the received signal indication; and
transmit the audio stream to the hearing assistance device using the first beamformed antenna gain pattern.

19. The non-transitory machine-readable storage medium of claim 18, wherein:
the hearing assistance device includes a first ear device and a second ear device;
the received signal indication includes a first ear signal indication associated with the first ear device and a second ear signal indication associated with the second ear device; and
the first beamformed antenna gain pattern is generated further based on the first ear signal indication and the second ear signal indication.

20. The non-transitory machine-readable storage medium of claim 18, the instructions further causing the computer-controlled device to:
receive a secondary received signal indication based on a second communication with a second hearing assistance device associated with a second user;
generate a second beamformed antenna gain pattern based on the received secondary received signal indication, the second beamformed antenna gain pattern different from the first beamformed antenna gain pattern; and
transmit the audio stream to the second hearing assistance device based on the second beamformed antenna gain pattern.
